(19) United States
(12) Patent Application Publication
(10) Pub. No.: US 2015/0246644 A1
(43) Pub. Date: Sep. 3, 2015

(54) Extendable Fork Forward Bicycle Carrier

(71) Applicants: James P. DETWEILER, Seymour, CT (US); Timothy J. MARKIS, Sandy Hook, CT (US); THULE SWEDEN AB, Hillerstorp (SE)

(72) Inventors: Timothy Makris, Sandy Hook, CT (US); James Detweiler, Bristol, CT (US)

(21) Appl. No.: 14/427,296

(22) PCT Filed: Sep. 10, 2013
(86) PCT No.: PCT/US2013/059067

§ 371 Date: Mar. 10, 2015

Related U.S. Application Data
(60) Provisional application No. 61/699,796, filed on Sep. 11, 2012.

(51) Int. Cl. B60R 9/10; B60R 9/048; B60R 9/045

(52) U.S. Cl. CPC B60R 9/10; B60R 9/045; B60R 9/048

(57) ABSTRACT

A vehicle rooftop mountable bicycle carrier including a load bar spanning element with front and rear foot attachments and having a fork mount with skewer positioned forward of the front foot attachment and including an extendable element with a wheel cradle couplable to the load bar spanning element and having the wheel cradle attached at the rear end of the element.

### FIELD

The instant disclosure relates to vehicle bicycle carriers. In particular, the disclosure relates to vehicle rooftop bicycle carriers.

### BACKGROUND

Transportation of bicycles by a vehicle is often required, either to transport a bicycle to a preferred point of use, such as a bicycle trail, or race, or to be serviced or repaired.

There are many types of bicycle carriers for attaching a bicycle to a vehicle, such as rear mounted carriers, hitch mounted carriers, or rooftop carriers. Carriers may also differ in the point of contact for carrying the bicycle. A transported bicycle may engage a bicycle carrier at its top tube, its wheels or, with some carriers, by the transported bicycle's rear wheel and front fork.

Whatever type of bicycle carrier may be used, it is preferable if the bicycle carrier may be useable for various sized bicycles. Often, the vehicle to which the bicycle carrier may be attached can be used to transport different sized bicycles. Even if the bicycle carrier user may not wish to adjust the carrier when in use, it is advantageous to the bicycle carrier manufacturer to have a single product that may be marketed to bicyclists with different sized bicycles.

It is further advantageous to have adjustable rooftop bicycle carriers that are useable on a wide variety of vehicles. Users of adjustable rooftop bicycle carriers with hatch-back type vehicles, however, have found adjustable rooftop carriers difficult to use. When extended to accommodate a larger bicycle, the rooftop bicycle carrier may interfere with the hatchback in the open position.

Thus, there is a need for a rooftop adjustable fork-secured bicycle carrier that, even when in an extended configuration, may limit interference with the use of a vehicle hatchback while still providing stable transport for the carried bicycles.

### BRIEF DESCRIPTION OF THE DRAWINGS

Implementation of the present application will now be described, by way of example only, with reference to the attached Figures, wherein:

FIG. 1 is a perspective view of a rooftop bicycle carrier in accordance with an exemplary implementation;

FIG. 2 is a side elevational view of the rooftop carrier illustrated in Fig.1;

FIG. 3 is a partial cross-sectional view taken along the line A-A in FIG. 1 of the rooftop carrier illustrated in FIG. 1.

FIG. 4 is a perspective view of the rooftop carrier illustrated in Fig.1 in an extended configuration; and

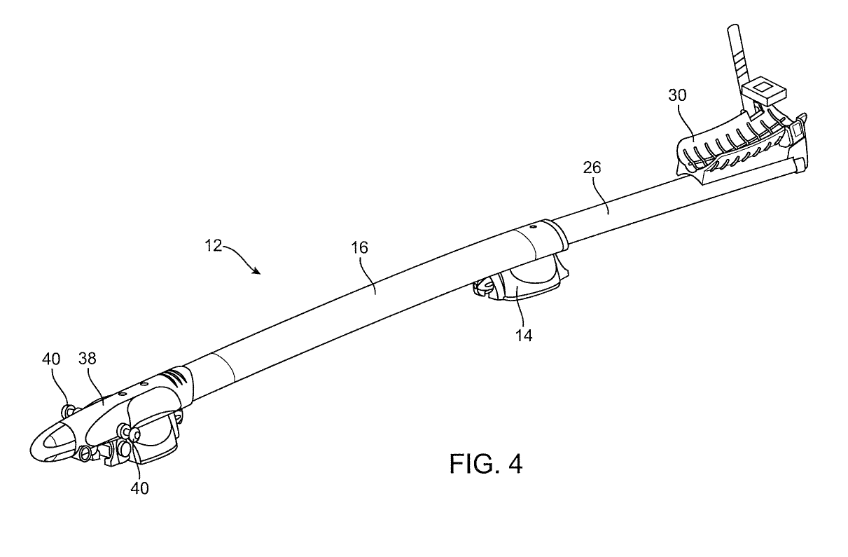

FIG. 5 is a close-up perspective view of the fork mount portion of the rooftop carrier illustrated in Fig.1 showing the location of the front load bar relative to the skewers of the fork mount.

### DETAILED DESCRIPTION

It will be appreciated that for simplicity and clarity of illustration, where appropriate, reference numerals have been repeated among different Figures to indicate corresponding or analogous elements. In addition, numerous specific details are set forth in order to provide a thorough understanding of the implementation described herein. However, it will be understood that the implementation described herein can be practiced without these specific details. In other instances, methods, procedures and components have not been described in detail so as not to obscure the related relevant function being described. Also, the description is not to be considered as limiting the scope of the implementations described herein.

The present disclosure presents a fork-secured rooftop bicycle carrier. The bicycle carrier includes an adjustable element or extension member that allows bicycles of various sizes to be carried by the carrier. The carrier includes a load bar spanning element attachable to the front and rear load bars of the carrying vehicle by using a second telescoping element that is attachable to the rear of the spanning element. The fork mount of the carrier is positioned near the front of the load bar spanning element with the fork skewers located between the front of the load bar spanning element and where the load bar spanning element attaches to the front load bar. The second extension element includes a wheel cradle positioned adjacent to the rear of the second element. In use, the front fork of a carried bicycle is attached to the skewers and the wheel cradle engages the rear wheel of the carried bicycle. The position of the wheel cradle allows the carrier to be adjustable while limiting interference with the operation of a hatchback and the position of the fork skewers increase stability of the carried bicycle.

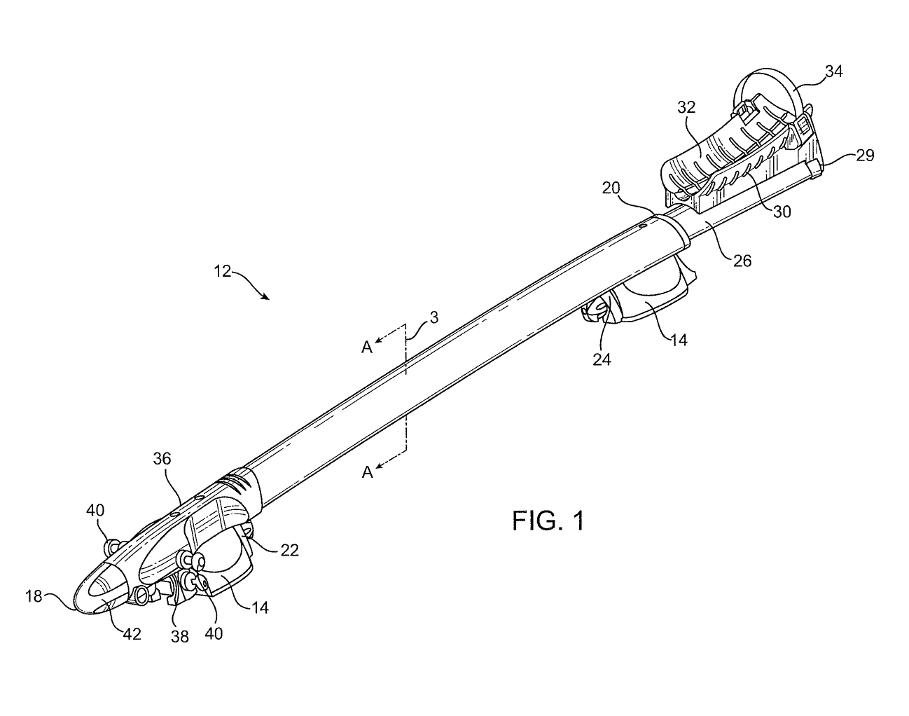

Referring to FIG. 1, an example of a fork rooftop bicycle carrier 12 is illustrated. The bicycle carrier 12 may be couple to a vehicle (not shown) through one or more load bars (not shown). The load bars are typically mounted crosswise on the roof of the vehicle but it will be recognized that the load bars may be mounted in multiple positions on the vehicle rooftop.

The bicycle carrier 12 shown in FIG. 1 is typically attached to the load bars (not shown) by two or more foot attachments 14. The foot attachments 14 may have various sizes or configurations to allow for coupling the bicycle carrier 12 to the load bars (not shown). The bicycle carrier may be attached by the foot attachment directly to the load bars or, in alternative embodiments, may be attached to intermediary elements which are attached to the load bars. The foot attachment 14 may have various sizes and configurations to allow for coupling the bicycle carrier 12 to the load bars (directly or indirectly). In FIG. 1, the foot attachments 14 are shown as separate elements. It will be recognized that the foot attachments 14 could be formed together with the bicycle carrier 12 or, in an alternative embodiment, could be formed as part of the load bars.

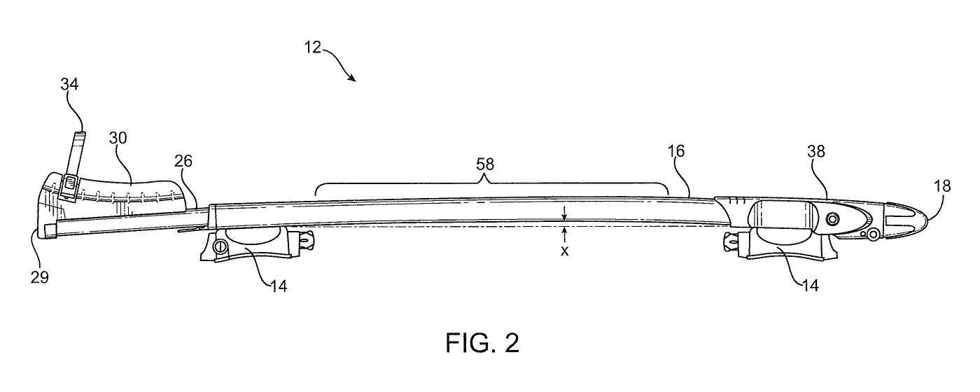

Turning to FIGS. 1 and 2, the bicycle carrier 12 includes a load bar spanning element 16. The load bar spanning element 16 is shown couplable in the foot attachments 14 proximate to a first (front) end 18 of the load bar spanning element 16 and proximate to a second (rear) end 20 of the load bar spanning element 16. The foot attachments 14 are couplable to the load bar spanning element 16 at a front foot attachment portion 22 of the load bar spanning element 16 proximate the front end 18 and at a rear attachment portion 24 of the load bar spanning element 16 proximate the rear end 20 of the load bar spanning element.

The bicycle carrier 12 shown in FIG. 1 also includes an extension element 26. The extension element 26 has a front end 28 (not shown) which is slidably engaged at the rear end 20 of the load bar spanning element 16 and has a rear end 29. The bicycle carrier 12 in FIG. 1 has a wheel cradle 30 coupled to the extension element 26 immediately proximate the rear end 29 of the extension element 26. The wheel cradle 30 includes a wheel receiving portion 32 and a retaining strap 34. The wheel receiving portion 32 can be configured based on the type of bicycle to be mounted thereon. For example, in at least one embodiment, different wheel cradles 30 can be available for mountain bicycles, road bicycles, or speed trial bicycles, among other types of wheels and frames. In yet other embodiments, such as the one illustrated, the wheel cradle 30 can include a wheel receiving portion 32 that can accommodate two or more types of bicycle tires and rims. The retaining strap 34, as illustrated, is an adjustable strap. While FIG. 1 shows a retaining strap 34 for retaining a bicycle wheel in the wheel cradle 30 and against the wheel receiving portion 32 of the wheel cradle 30, it will be recognized that a bicycle may be retained in the wheel cradle 30 by other methods.

Again turning to Fig.l, the bicycle carrier 12 includes a fork anchor 36. The fork anchor 36 is positioned along the load bar spanning element 16 proximate the front end 18 of the load bar spanning element 16. The fork anchor 36 also includes a skewer 38. The skewer 38 is configured to releasably couple the transported bicycle fork to the bicycle anchor 36. The skewer 38 has two skewer heads 40. The movement of the skewer heads may be controlled by rotating the manually operable actuator 42. In FIG. 1, the actuator 42 is shown having a substantially conical shape. In other embodiments, the actuator may be shaped as, but not limited to, a knob, handle, lever, pin or other component to adjust the position of the skewer heads 40.

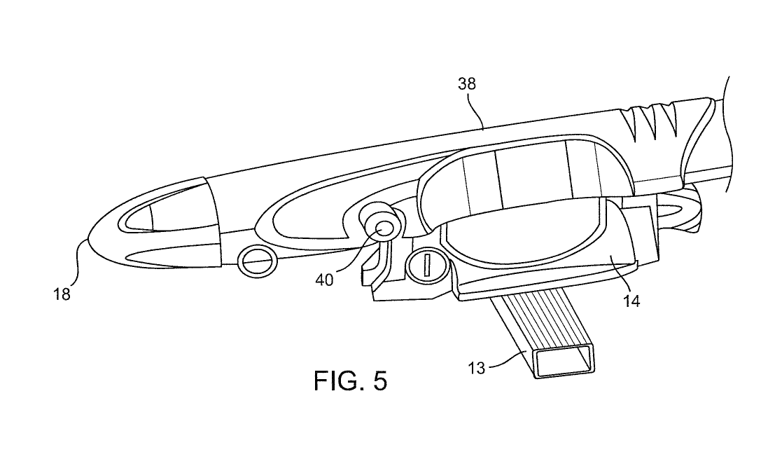

Turning now to FIG. 2, it is clear that the wheel cradle 30 is positioned substantially adjacent to the rear end 29 of the extension element 26. As shown in FIG. 2, the skewer 38 is positioned between the front attachment portion 22 of the load bar spanning element 16 and the front end 18 of the load bar spanning element. FIG. 2 makes it clear that the skewer 38 is positioned forwardly of, and not directly above the front foot attachment 14, and in turn, the cross bar 13 to which the foot 14 is attached (see FIG. 5).

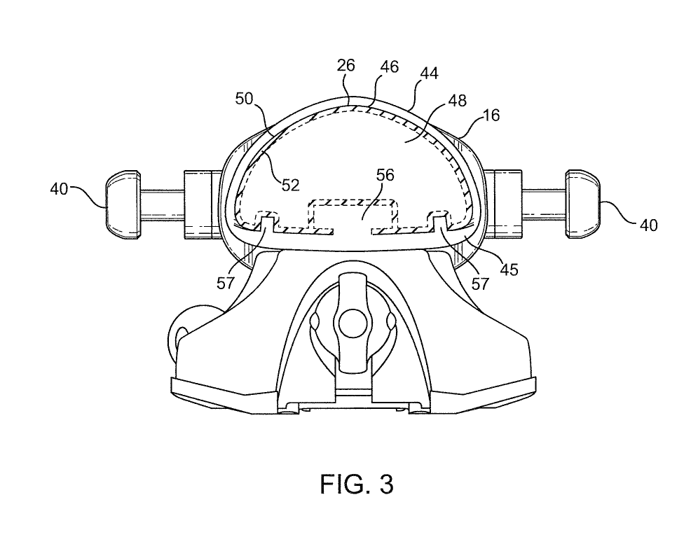

FIG. 3 is a cross-sectional view of the bicycle carrier 12 along the segment A-A of FIG. 1. FIG. 3 shows the load bar spanning element 16 having a generally flat bottom 45 and an arched top 44 of the load bar spanning element 16 foamed with an exterior surface and an interior surface 46 to define an interior space 48 into which the extension element 26 couples to the load bar spanning element 16. The extension element 26 is configured with an exterior surface 50 and an interior surface 52 to define a generally hollow space. It will be understood, however, that the configuration of FIG. 3 is shown as an example only and the engagement and shape of the load bar spanning element 16 and/or the extension element 26 may be modified.

The load bar spanning element 16 is configured with the interior surface 46 of the bottom 45 having guide rails 57 on either side of an engagement channel 56 substantially in the center. Likewise, the bottom exterior surface of the extension element 26 is configured to engage the guide rails 57 when coupled to the load bar spanning element 16.

Again turning to FIG. 2, it is clear that the length of the load bar spanning element 16 is arched. In particular, if measured at the midsection portion 58 of the load bar spanning element 16 between the front foot attachment portion 22 and the rear foot attachment portion 24, the exterior surface 44 of the bottom 45 of the load bar spanning element 16 is shown to be a distance x above a plane connecting the front foot attachment portion and the rear foot attachment portion. The value of x may vary and could depend upon the length of load bar spanning element 16. Furthermore, although FIG. 2 may only clearly illustrate that the load bar spanning element 16 is arched upward, it should be understood that because at least a portion of the extension element 26 engages with and is extendable into the load bar spanning element 16, the extension element 26 may also, at least in part, be arched. It should also be clear, however, that alternative embodiments could include a flat load bar spanning element 16 (i.e., the value of x=0) or could include a downwardly arched load bar spanning element 16 (i.e., the value of x being negative).

Exemplary implementations have been described hereinabove regarding implementations of a rooftop bicycle carrier. Various modification to and departures from the disclosed implementations will occur to those having skill in the art. The subject matter that is intended to be governed by this disclosure is set forth in the following claims.

1. A rooftop bicycle carrier comprising:
a load bar spanning element having a front end and a rear end, the load bar spanning element being attachable to a first load bar at a front attachment portion proximate the front end of the load bar spanning element and attachable to a second load bar at a rear attachment portion proximate the rear end of the load bar spanning element;
an extension element, having a front end and a rear end, the front end of the extension element being slidably engaged with the rear end of the load bar spanning element;
a fork mount with skewers, the fork mount attached to the load bar spanning element proximate to the front end of the load bar spanning element with the skewers positioned between the front attachment portion and the front end of the load bar spanning element; and
a wheel cradle attached to the extension element and positioned proximate the rear end of the extension element.

2. A rooftop bicycle carrier comprising:
a load bar spanning element having a front end and a rear end, the load bar spanning element being attachable to a first load bar at a front attachment portion proximate the front end of the load bar spanning element and attachable to a second load bar at a rear attachment portion proximate the rear end of the load bar spanning element;
an extension element, having a front end and a rear end, the front end of the extension element being slidably engaged with the rear end of the load bar spanning element;
a bicycle point of contact located on the extension element and positioned proximate the rear end of the extension element; and
a bicycle securement point of contact located on the load bar spanning element proximate to the front end of the load bar spanning element and positioned between the front attachment portion and the front end of the load bar spanning element.

3. The rooftop bicycle carrier of claim 2, wherein the bicycle point of contact located on the extension element is a wheel cradle attached to the extension element.

4. The rooftop bicycle carrier of claim 3, wherein the bicycle point of contact located on the load bar spanning element is a fork mount attached to the load bar spanning element.

5. The rooftop bicycle carrier of claim 4, wherein the fork mount comprises skewers positioned between the front attachment portion and the front end of the load bar spanning element.

6. The rooftop bicycle carrier of claim 1, wherein the load bar spanning element is lengthwise upwardly bowed from the front end to the rear end.

7. The rooftop bicycle carrier of claim 1, wherein the load bar spanning element has a generally flat bottom surface and a curved top surface, and the load bar spanning element is tubular in construction thereby forming an elongate void therein.

8. The rooftop bicycle carrier of claim 7, wherein the load bar spanning element has an interior surface surrounding the elongate void and which is configured to form at least one guide rail within the void.

9. The rooftop bicycle carrier of claim 8, wherein at least a portion of the extension element is configured to engage the at least one guide rail.

10. The rooftop bicycle carrier of claim 9, wherein the engagement between the extension element and the at least one guide rail is a tongue-in-groove mating engagement.

11. The rooftop bicycle carrier of claim 1, wherein the load bar spanning element is couplable to the load bar via foot attachments, the foot attachments being located proximate to the front end of the load bar spanning element and proximate to the rear end of the load bar spanning element.

12. The rooftop bicycle carrier of claim 1, wherein the wheel cradle includes a wheel receiving portion and a retaining strap.

13. The rooftop bicycle carrier of claim 12, wherein the wheel receiving portion is configured to accommodate at least two differently sized bicycle wheels.

14. The rooftop bicycle carrier of claim 1, wherein a top surface of the load bar spanning element is widthwise upwardly arched.
